(19) United States
(12) Patent Application Publication
(10) Pub. No.: US 2022/0013959 A1
(43) Pub. Date: Jan. 13, 2022

(54) MANUFACTURING SYSTEM FOR FITTED BODY

(71) Applicants: YAZAKI CORPORATION, Tokyo (JP); HONDA MOTOR CO., LTD., Tokyo (JP)

(72) Inventors: Tomohiro Kudo, Kumamoto (JP); Tomoyuki Miyakawa, Utsunomiya-shi (JP); Tomoyoshi Fukaya, Utsunomiya-shi (JP); Kozo Oishi, Utsunomiya-shi (JP)

(21) Appl. No.: 17/483,811

(22) Filed: Sep. 24, 2021

Related U.S. Application Data
(63) Continuation of application No. PCT/JP2020/008731, filed on Mar. 2, 2020.

(30) Foreign Application Priority Data
Mar. 26, 2019 (JP) 2019-059305

(51) Int. Cl. H01R 13/631; H01R 13/52

(52) U.S. Cl. CPC H01R 13/631; H01R 13/5202

(57) ABSTRACT

A manufacturing system for a fitted body is configured to fit the first connector selected based on the functions of the fitted body and the second connector to manufacture the fitted body. The first connectors each has a first function portion differing from each other in accordance with functions of the fitted body. The second connector has a common second function portion allowing an engagement with the first function portion.

### CROSS-REFERENCE TO RELATED APPLICATIONS

This is a continuation of International Application No. PCT/JP2020/008731 filed on Mar. 2, 2020, and claims priority from Japanese Patent Application No. 2019-059305 filed on Mar. 26, 2019, the entire content of which is incorporated herein by reference.

### TECHNICAL FIELD

The present invention relates to a manufacturing system for manufacturing a fitted body in each of which one connector and the other connector are fitted to each other.

### BACKGROUND ART

Electric connection has been heretofore made in such a manner that one connector and the other connector e.g. a male connector and a female connector) are fitted to each other on any of various wirings etc. laid between electrical appliances or between an electrical appliance and a power supply. In other words, a fitted body serving for establishing such electric connection has been manufactured.

In such a type of fitted body, a structure for achieving one of various functions in accordance with an application of the fitted body may be provided in each of connectors if occasions demand. For example, in order to provide a waterproof function in a fitted body, a packing may be attached to one connector and the shape of the other connector may be designed to be brought into press contact with the packing during fitting. In addition, a simple waterproof function may be provided in another fitted body by press-fitting one connector provided with a ridge portion to the other connector by use of the ridge portion.

As for details of the above fitted bodies, refer to JP 2005-346940 A and JP 7-153523 A.

When one of the various functions (such as the waterproof function) is provided in a fitted body as in the aforementioned various fitted bodies according to the background art, each of connectors generally has a shape or structure corresponding to the function. That is, each of the connectors is designed into a dedicated shape etc. suited to one of the various functions so that the fitted body can exert the function. However, due to such a dedicated design, a connector designed for one function normally cannot be suitably fitted to a connector designed for another function. That is, compatibility among the connectors for the fitted bodies according to the background art is low. However, it is desirable to enhance compatibility among the multiple types of connectors from the viewpoint of reducing manufacturing cost of the fitted bodies.

### SUMMARY OF INVENTION

Aspect of non-limiting embodiments of the present disclosure relates to provide a fitted body manufacturing system which can manufacture multiple types of fitted bodies at low cost and with excellent compatibility.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a manufacturing system for a fitted body, the fitted body including: a first connector selected from a plurality of types of the first connectors; and a single type of a second connector fitted to the first connector,

the plurality of types of the first connectors each having a first function portion differing from each other in accordance with functions of the fitted body;

the second connector having a common second function portion allowing an engagement with the first function portion, the second function portion being a ridge portion located in an outer wall face of the second connector; and

the manufacturing system being configured to select, upon the fitted body serving a simple waterproof function, the first connector having an inner wall face, as the first function portion, to provide the simple waterproof function by abutting the inner wall face against the ridge portion;

the manufacturing system being configured to select, upon the fitted body serving a first waterproof function and a function of suppressing intrusion of foreign matters, the first connector having a first ceiling component, as the first function portion, to provide the first waterproof function by making press contact of one portion of the first ceiling component with the second connector and to provide the function of suppressing intrusion of foreign matters by locating another portion of the first ceiling component and the ridge portion facing each other through a gap in a protruding direction of the ridge portion;

the manufacturing system being configured to select, upon the fitted body serving a second waterproof function, the first connector having a second ceiling component, as the first function portion, to provide the second waterproof function by making press contact of one portion of the second ceiling component with the second connector and to provide a function of enhancing the second waterproof function by abutting another portion of the second ceiling component against the ridge portion; and the manufacturing system being configured to fit the selected one of the first connectors and the second connector to manufacture the fitted body, the fitted body serving the functions provided by cooperation of the first function portion and the second function portion.

### BRIEF DESCRIPTION OF DRAWINGS

Exemplary embodiment(s) of the present invention will be described in detail based on the following figures, wherein:

FIG. 1 is an exploded perspective view of two types of fitted bodies which can be selectively manufactured by a manufacturing system according to an embodiment of the present invention;

FIG. 2 is a perspective view of a single type of female housing shown in FIG. 1;

FIG. 3A is a main sectional view of a simple waterproof fitted body in which a single type of female connector and a simple waterproof male connector are fitted to each other, and

FIG. 3B is an enlarged view of a portion A of FIG. 3A;

FIG. 4A is a main sectional view of a waterproof fitted body in which the single type of female connector and a waterproof male connector are fitted to each other, and FIG. 4B is an enlarged view of a portion B of FIG. 4A; and

FIG. 5 is a view corresponding to FIG. 4B to show another example of the waterproof fitted body in which the single type of female connector and the waterproof male connector are fitted to each other.

### DESCRIPTION OF EMBODIMENTS

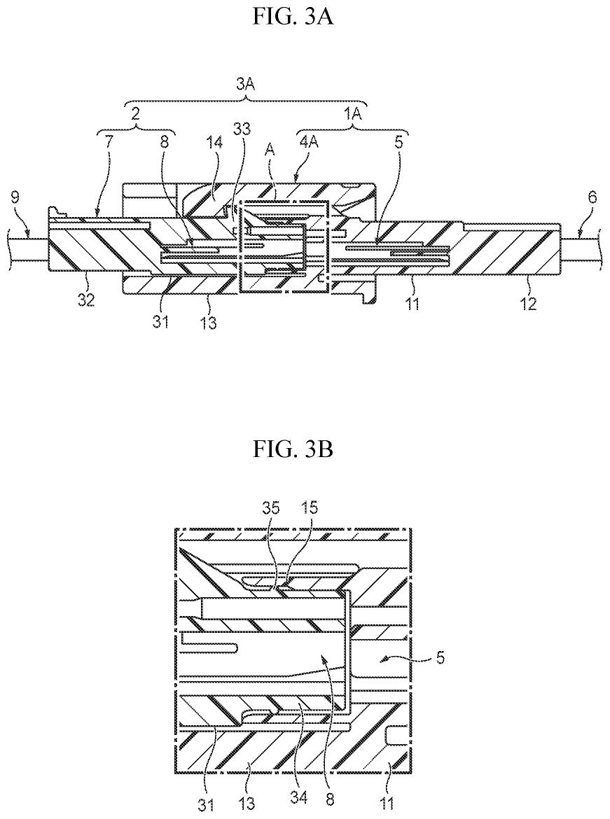

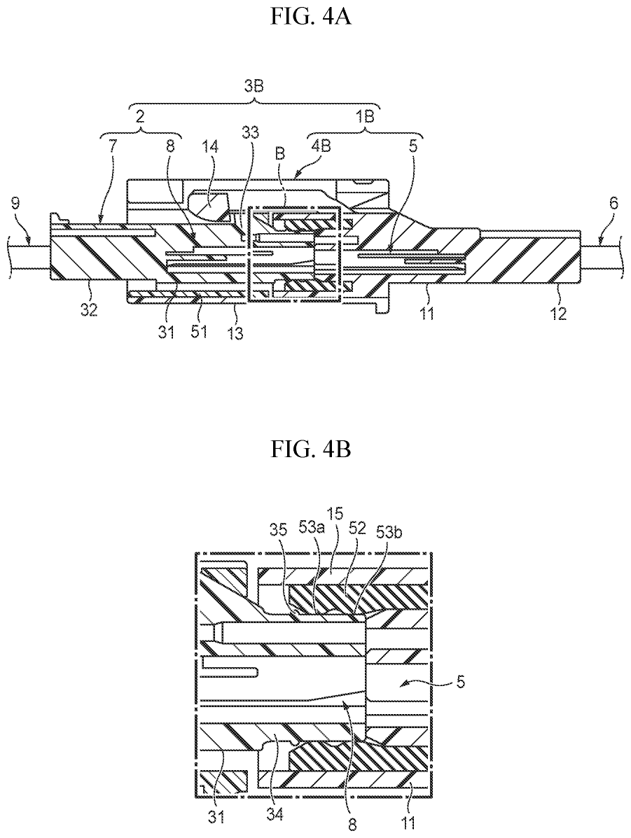

Two types of fitted bodies 3A and 3B which can be selectively manufactured by a manufacturing system according to an embodiment of the present invention will be described below with reference to the drawings. The simple waterproof fitted body 3A (see FIGS. 3A and 3B) is a fitted body in which, of male connectors IA and 1B classified into two types, the simple waterproof male connector 1A and a female connector 2 classified into a single type are fitted to each other. The waterproof fitted body 3B (see FIGS. 4A and 4B) is a fitted body in which, of the male connectors 1A and 1B classified into the two types, the waterproof male connector 1B and the female connector 2 classified into the single type are fitted to each other.

In the simple waterproof fitted body 3A, of two types of male housings 4A and 4B, the simple waterproof male housing 4A used for the simple waterproof male connector I A and a female housing 7 of the female connector 2 are fitted to each other so that electric wires 6 connected to male terminals 5 received in the simple waterproof male housing 4A and electric wires 9 connected to female terminals 8 received in the female housing 7 are electrically connected to each other.

In the waterproof filled body 3B, of the two types of male housings 4A and 4B, the waterproof male housing 4B used for the waterproof male connector 1B and the female housing 7 of the female connector 2 are fitted to each other so that the electric wires 6 connected to the male terminals 5 received in the waterproof male housing 4B and the electric wires 9 connected to the female terminals 8 received in the female housing 7 are electrically connected to each other.

The two types of fitted bodies 3A and 3B, the two types of male connectors 1A and 1B and the two types of male housings 4A and 4B may be hereinafter referred to as “fitted. bodies 3”, “male connectors 1” and “male housings 4” respectively when they do not have to be particularly distinguished from each other for convenience of explanation.

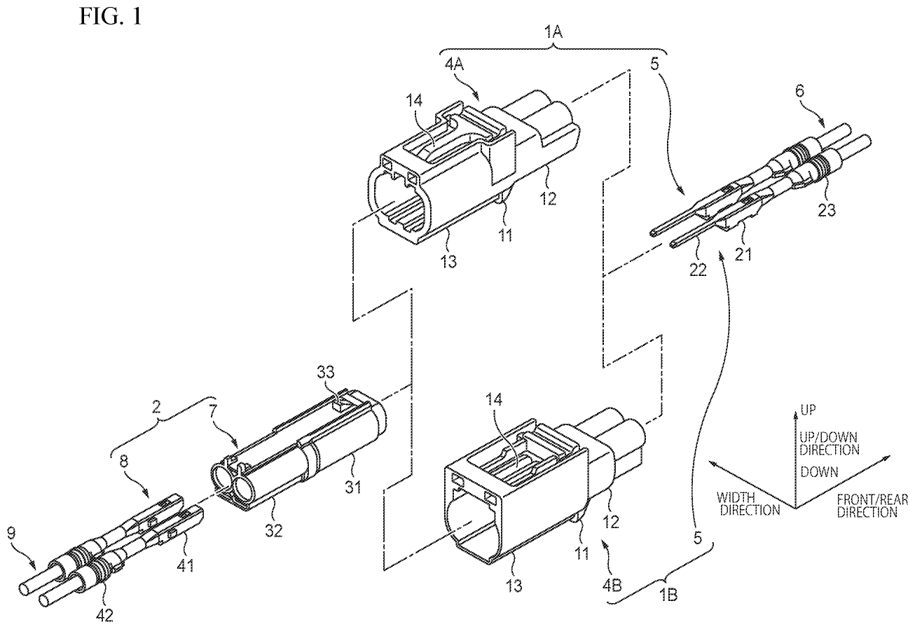

“Front/rear direction”, “width direction”, “up/down direction”, “up” and “down” will be defined as shown in FIG. 1. The “front/rear direction”, the “width direction” and the “up/down direction” intersect perpendicularly to one another. The front/rear direction is consistent with a fitting direction between the male connector 1 (the male housing 4) and the female connector 2 (the female housing 7), an insertion direction of the male terminals 5 into the male housing 4, and an insertion direction of the female terminals 8 into the female housing 7. As to each of the male connector 1 and the female connector 2, a front face side in a fitting direction in which a mated connector is fitted is defined as front side, and a back face side opposite to the front face side in the fitting direction is defined as rear side. First, the male connector 1 will be described below.

As shown in FIG. 1, FIGS. 3A and 3B and FIGS. 4A and 4B, the male connector 1 is constituted by the male housing 4 made of a resin, and the male terminals 5 paired with each other. The male housing 4 is provided with a base portion 11, an electric wire retention portion 12, and a hood portion 13 integrally. The electric wire retention portion 12 extends rearward from the base portion 11. The hood portion 13 extends frontward from the base portion 11.

Paired terminal reception chambers (not shown) penetrating the base portion 11 in the front/rear direction are formed inside the base portion 11 so as to be arranged in the width direction. Paired terminal insertion holes (not shown) penetrating the electric wire retention portion 12 in the front/rear direction are formed inside the electric wire retention portion 12 so as to be arranged in the width direction and so as to communicate with the paired terminal reception chambers respectively. The hood portion 13 has a cylindrical shape protruding frontward while surrounding front end portions of the paired terminal reception chambers.

Each of the male terminals 5 has a body portion 21 and a rod-like tab portion 22. The body portion 21 extends in the front/rear direction of the male terminals 5. The rod-like tab portion 22 protrudes frontward from the body portion 21. An end of a corresponding one of the electric wires 6 is connected to a rear side of the body portion 21. An annular rubber plug 23 is attached to the end of the corresponding electric wire 6.

The paired male terminals 5 to which the electric wires 6 have been connected are inserted from the rear into the male housing 4 and received therein. At a stage halfway through the reception of the male terminals 5, lances (not shown) provided in the terminal reception chambers are elastically deformed in a direction to leave the body portions 21 of the male terminals 5. In a state in which the male terminals 5 have been completely received, the lances (not shown) are elastically recovered in a direction to approach the body portions 21 of the male terminals 5 to thereby lock steps (not shown) of the body portions 21 of the male terminals 5. Thus, the male terminals 5 are prevented from dropping out of the male housing 4 toward the rear.

In the state in which the paired male terminals 5 have been received completely, the body portions 21 of the paired male terminals 5 are received in the paired terminal reception chambers of the base portion 11. The tab portions 22 of the paired male terminals 5 protrude frontward from the front end portions of the paired terminal reception chambers to be positioned inside an internal space of the hood portion 13. Ends of the paired electric wires 6 connected to the paired male terminals 5 are received and retained in the paired terminal insertion holes of the electric wire retention portion 12. Thus, the body portions 21 of the male terminals 5 are received in the terminal reception chambers of the base portion 11 after passing through the terminal insertion holes of the electric wire retention portion 12.

At a stage where the male terminals 5 have been received completely, gaps between outer circumferential faces of the ends of the electric wires 6 and inner circumferential faces of the terminal insertion holes of the electric wire retention portion 12 are sealed by the rubber plugs 23. Thus, water can be prevented from intruding into the male housing 4 from the rear side of the male housing 4.

Next, the female connector 2 will be described. As shown in FIG. 1 to FIG. 4B, the female connector 2 is constituted by the female housing 7 made of a resin, and the female terminals 8 paired with each other. The female housing 7 is provided with a base portion 31 and an electric wire retention portion 32 integrally. The electric wire retention portion 32 extends rearward from the base portion 31.

Paired terminal reception chambers (not shown) penetrating the base portion 31 in the front/rear direction are formed inside the base portion 31 so as to be arranged in the width direction. Paired terminal insertion holes (not shown) penetrating the electric wire retention portion 32 in the front/rear direction are formed inside the electric wire retention portion 32 so as to be arranged in the width direction and so as to communicate with the paired terminal reception chambers respectively.

As shown in FIG. 1, each of the female terminals 8 has a cylindrical body portion 41 which extends in the front/rear direction. An end of a corresponding one of the electric wires 9 is connected to a rear side of the body portion 41. An annular rubber plug 42 is attached to the end of the corresponding electric wire 9.

The paired female terminals 8 to which the electric wires 9 have been connected are inserted from the rear into the female housing 7 and received therein. At a stage halfway through the reception of the female terminals 8, lances (not shown) provided in the terminal reception chambers are elastically deformed in a direction to leave the body portions 41 of the female terminals 8. In a state in which the female terminals 8 have been received completely, the lances (not shown) are elastically recovered in a direction to approach the body portions 41 of the female terminals 8 to thereby lock steps (not shown) of the body portions 41 of the female terminals 8. Thus, the female terminals 8 can be prevented from dropping out of the female housing 7 toward the rear.

In the state in which the paired female terminals 8 have been received completely, the body portions 41 of the paired female terminals 8 are received in the paired terminal reception chambers of the base portion 31. Ends of the paired electric wires 9 connected to the paired female terminals 8 are received and retained in the paired terminal insertion holes of the electric wire retention portion 32. Thus, the body portions 41 of the female terminals 8 are received in the terminal reception chambers of the base portion 31 after passing through the terminal insertion holes of the electric wire retention portion 32.

At a stage where the female terminals 8 have been received completely, gaps between outer circumferential faces of the ends of the electric wires 9 and inner circumferential faces of the terminal insertion holes of the electric wire retention portion 32 are sealed by the rubber plugs 42. Thus, water can be prevented from intruding into the female housing 7 from the rear side of the female housing 7.

Fitting between the male housing 4 and the female housing 7 can be accomplished by inserting the base portion 31 of the female housing 7 into the hood portion 13 of the male housing 4 and making a front end face of the base portion 31 of the female housing 7 and a front end face of the base portion 11 of the male housing 4 butt against each other inside the hood portion 13.

In a state in which the male housing 4 and the female housing 7 have been fitted to each other completely, the tab portions 22 of the male terminals 5 received in the male housing 4 are inserted in the cylindrical body portions 41 of the female terminals 8 received in the female housing 7. Thus, the electric wires 6 connected to the male terminals 5 and the electric wires 9 connected to the female terminals 8 are electrically connected to each other

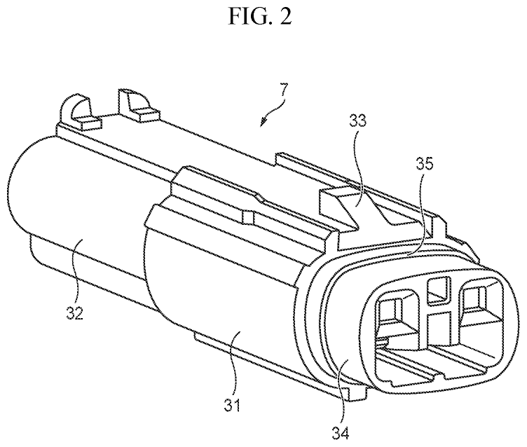

Further, a lock arm 14 (see FIG. 1) formed in the male housing 4 is engaged with a lock beak 33 (see FIG. 1 and FIG. 2) formed in the female housing 7 (see FIG. 3A and FIG. 4A). Thus, the male housing 4 and the female housing 7 are maintained at the completely fitted state.

The male housing 4 and the female housing 7 are configured so that a function (hereinafter called “waterproof function in a fitting portion”) of preventing water from intruding into the male housing 4 and the female housing 7 from the outside through a gap between the front end face of the base portion 31 of the female housing 7 and the front end face of the base portion 11 of the male housing 4 which have been made to butt against each other can be exerted in the completely fined state between the male housing 4 and the female housing 7. This point will be described below in detail.

Waterproof function in the fitting portion of the simple waterproof fitted body 3A is described in detail below In the simple waterproof fitted body 3A shown in FIGS. 3A and 3B, the simple waterproof male housing 4A of the male housings 4A and 4B classified into the two types is fitted to the female housing 7 classified into the single type, as described above.

In the female housing 7, as shown in FIG. 2, an outer wall face of the cylindrical front end face in the base portion 31 functions as a press-fitting portion 34 in order to exert the waterproof function in the fitting portion. An annular ridge portion 35 (second function portion) is provided in the press-fitting portion 34.

In the simple waterproof male housing 4A, as shown in FIG. 3A and FIG. 3B, an annular press-fitting wall 15 protruding frontward from the front end face of the base portion 11 is provided integrally inside the internal space of the hood portion 13 in order to exert the waterproof function in the filling portion.

As shown in FIGS. 3A and 3B (particularly see FIG. 3B), the press-fitting portion 34 of the female housing 7 is press-filled to the press-fitting wall 15 of the simple waterproof male housing 4A so that the annular ridge portion 35 of the press-fitting portion 34 of the female housing 7 can make press contact with an inner wall face (the first function portion) of the press-fitting wall 15 entirely circumferentially in the completely fitted state between the simple waterproof male housing 4A and the female housing 7 (i.e. the simple waterproof fitted body 3A). As a result, the ridge portion 35 makes press contact with the inner wall face of the press-fitting wall 15 entirely circumferentially so that the simple waterproof function can be exerted.

Waterproof function in the fitting portion of the waterproof fitted body 3B is described in detail below. In the waterproof fitted body 3B shown in FIGS. 4A and 4B, the waterproof male housing 4B of the male housings 4.A and 4B classified into the two types is fitted to the female housing 7 classified into the single type. In the waterproof male housing 4B, a radial dimension of the inner wall face of the press-fitting wall 15 and a radial dimension of the internal space of the hood portion 13 are larger than the simple waterproof male housing 4A by thickness of a cylindrical packing 52 due to the use of the packing 52, as will be described later. Due to this fact, a spacer 51 for filling a gap between an inner wall face of the hood portion 13 and an outer wall face of the female housing 7 is interposed between the hood portion 13 and the female housing 7, as shown in FIG. 4A.

In the female housing 7, as described above, the annular ridge portion 35 (the second function portion) is provided in the press-fitting portion 34 in order to exert the waterproof function in the fitting portion. On the other hand, in the waterproof male housing 4B, as shown in FIG. 4A and FIG. 4B. The cylindrical packing 52 (the first function portion) made of rubber is inserted and fixed to closely adhere to the inner wall face of the press-fitting wall 15 in order to exert the waterproof function in the fitting portion. A plurality of (two in the present example) annular lip portions 53a and 53h protruding radially inward are provided in an inner wall face of the packing 52 so as to be arranged in the front/rear direction.

In the completely fitted state between the waterproof male housing 4B and the female housing 7 (i.e. the waterproof fitted body 313), as shown in FIGS. 4A and 4B (particularly see FIG. 4B), the lip portion 53h (rear side lip portion) of the packing 52 makes press contact with one portion of the press-fitting portion 34 of the female housing 7 entirely circumferentially, and the lip portion 53a (front side lip portion) of the packing 52 faces the ridge portion 35 through a gap. The ridge portion 35 is positioned in front of the lip portion 53a. As a result, the lip portion 53h of the packing 52 makes press contact with the portion of the press-fitting portion 34 of the female housing 7 so that the waterproof function is exerted. At the same time, the lip portion 53a of the packing 52 faces the ridge portion 35 through the gap so that a function of suppressing intrusion of foreign matters is exerted. In other words, a different function from the simple waterproof function exerted by the simple waterproof fitted body 3A can be exerted by the waterproof fitted body 3B.

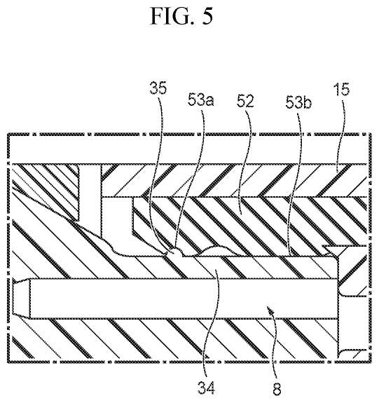

Incidentally, the waterproof fitted body 3B may be configured so that the lip portion 53b of the packing 52 makes press contact with the portion of the press-fitting portion 34 of the female housing 7 entirely circumferentially and the lip portion 53a of the packing 52 makes press contact with the ridge portion 35 entirely circumferentially, as shown in FIG. 5, As a result, the lip portion 53b of the packing 52 makes press contact with the portion of the press-fitting portion 34 of the female housing 7 so that the waterproof function is exerted.

At the same time, the lip portion 53a of the packing 52 makes press contact with the ridge portion 35 so that a function of enhancing the waterproof function is exerted. In other words, a different function from the simple waterproof function exerted by the simple waterproof fitted body 3A can be also exerted by the waterproof fitted body 3B.

The fitted body manufacturing system according to the embodiment of the present invention as described above is designed to fit the female connector 2 to one of the male connectors 1A and 1B so as to manufacture one of the fitted bodies 3A and 3B. The male connectors 1A and 1B classified into the “multiple” types have the first function portions different respectively in accordance with the functions of the fitted bodies 3A and 3B. The female connector 2 classified into the “single” type has the “common” second function portion applicable for universal use. Thus, the “multiple” types of fitted bodies 3A and 3B can be manufactured at lower cost and more reasonably than that in a case where a plurality of male connectors and a plurality of female connectors are prepared as in the background art. Accordingly, the fitted body manufacturing system having the present configuration can manufacture the multiple types of fitted bodies 3A and 3B at lower cost.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

In the aforementioned embodiment, the waterproof function is used as the function exerted by the fitted body 3. Alternatively, any other function than the waterproof function may be used as the function exerted by the fitted body 3. In addition, in the aforementioned embodiment, one first connector selected from the first connectors classified into the two types is fitted to the second connector classified into the single type. However, one first connector selected from first connectors classified into three or more types may be fitted to the second connector classified into the single type.

According to the above exemplary embodiments, a manufacturing system for a fitted body (3A, 3B), the fitted body (3A, 3B) including: a first connector (1A, 1B) selected from a plurality of types of the first connector (1A, 1B); and a single type of a second connector (2) fitted to the first connector (1A, 1B),

the plurality of types of the first connector (1A, 1B) each having a first function portion (15, 52) differing from each other in accordance with functions of the fitted body (3A, 3B);

the second connector (2) having a common second function portion (35) allowing an engagement with the first function portion (15, 52). The second function portion (35) being a ridge portion (35) located in an outer wall face of the second connector (2);

the manufacturing system is configured to select, upon the fitted body (3A, 3B) serving a simple waterproof function, the first connector (IA) having an inner wall face (15), as the first function portion (15, 52), to provide the simple waterproof function by abutting the inner wall face (15) against the ridge portion (35);

the manufacturing system is configured to select, upon the fitted body (3A. 3B) serving a first waterproof function and a function of suppressing intrusion of foreign matters, the first connector (1B) having a first ceiling component (52), as the first function portion (15, 52), to provide the first waterproof function by making press contact of one portion (53b) of the first ceiling component (52) with the second connector (2) and to provide the function of suppressing intrusion of foreign matters by locating another portion (53a) of the first ceiling component (52) and the ridge portion (35) facing each other through a gap in a protruding direction of the ridge portion (35);

the manufacturing system is configured to select, upon the fitted body (3A, 3B) serving a second waterproof function, the first connector (1B) having a second ceiling component (52), as the first function portion (15, 52), to provide the second waterproof function by making press contact of one portion (53b) of the second ceiling component (52) with the second connector (2) and to provide a function of enhancing the second waterproof function by abutting another portion (53a) of the second ceiling component (52) against the ridge portion (35); and

the manufacturing system is configured to fit the selected one of the first connector (1A, 1B) and the second connector (2) to manufacture the fitted body (3A, 3B), the fitted body (3A, 3B) serving the functions provided by cooperation of the first function portion (15, 52) and the second function portion (35).

According to the above-described manufacturing system, the fitted body manufacturing system is designed to fit the second connector (e.g. a female connector) to one of the first connectors (e.g. male connectors) so as to manufacture one of the fitted bodies. The first connectors classified into the “multiple” types have the first function portions “different” respectively in accordance with the functions of the fitted bodies. The second connector classified into the “single” type has the “common” second function portion applicable for universal use. Thus, the fitted bodies can be manufactured at lower cost and. more reasonably than those in a case where a plurality of specially designed first connectors and a plurality of specially designed second connectors are prepared as in the background art. Accordingly, the fitted body manufacturing system having the present configuration can manufacture the multiple types of fitted bodies at lower cost and with more excellent compatibility than the background-art manufacturing system.

According to the above manufacturing system, the ridge portion (i.e. the second function portion) provided in the second connector abuts against the inner wall face of the first connector (the simple waterproof connector) so that the simple waterproof function is exerted. In addition, while one portion of the second connector makes press contact with the ceiling component belonging to the first connector (the waterproof connector), the ridge portion (i.e. the second function portion) of the second connector faces the ceiling component of the first connector through a gap. Thus, the waterproof function is exerted by the ceiling component. In addition thereto, the function of damming foreign matters is exerted by the ridge portion so as to prevent the foreign matters from approaching the ceiling component from the outside. Thus, each of the multiple types of fitted bodies can be manufactured by combining the second connector belonging to the “single” type excellent in compatibility with the first connector belonging to one of the “multiple” types.

According to the above manufacturing system, the ridge portion (i.e. the second function portion) provided in the second connector abuts against the inner wall face of the first connector (the simple waterproof connector). Thus, the simple waterproof function is exerted. In addition, while one portion of the second connector makes press contact with the ceiling component belonging to the first connector (the waterproof connector), the ridge portion (i.e. the second function portion) of the second connector further abuts against the ceiling component. Thus, a higher-level waterproof function is exerted by the ceiling component and the ridge portion. Thus, each of the multiple types of fitted bodies can be manufactured by combining the second connector belonging to the “single” type excellent in compatibility with the first connector belonging to one of the “multiple” types.

In the manufacturing system,

the first ceiling component (52) may be a packing (52) having: a first lip portion (53b) annularly protruding as the one portion (53b) to make press contact with the second connector (2); and a second lip portion (53a) annularly protruding as the another portion (53a) to face to the ridge portion (35) through the gap.

In the manufacturing system,

the second ceiling component (52) may be a packing (52) having: a first lip portion (53b) annularly protruding as the one portion (53b) to make press contact with the second connector (2); and a second lip portion (53a) annularly protruding as the another portion (53a) to abut against the ridge portion (35).

According to the present invention, it is possible to provide a fitted body manufacturing system which can manufacture multiple types of fitted bodies at low cost.

The fitted body according to the invention can manufacture multiple types of fitted bodies at low cost and with excellent compatibility. The invention having this effect is useful, for example, for making a fitted body of one connector and another connector.

What is claimed is:

1. A manufacturing system for a fitted body, the fitted body including: a first connector selected from a plurality of types of the first connectors; and a single type of a second connector fitted to the first connector,
the plurality of types of the first connectors each having a first function portion differing from each other in accordance with functions of the fitted body;
the second connector having a common second function portion allowing an engagement with the first function portion, the second function portion being a ridge portion located in an outer wall face of the second connector;
the manufacturing system being configured to select, upon the fitted body serving a simple waterproof function, the first connector having an inner wall face, as the first function portion, to provide the simple waterproof function by abutting the inner wall face against the ridge portion;
the manufacturing system being configured to select, upon the fitted body serving a first waterproof function and a function of suppressing intrusion of foreign matters, the first connector having a first ceiling component, as the first function portion, to provide the first waterproof function by making press contact of one portion of the first ceiling component with the second connector and to provide the function of suppressing intrusion of foreign matters by locating another portion of the first ceiling component and the ridge portion facing each other through a gap in a protruding direction of the ridge portion;
the manufacturing system being configured to select, upon the fitted body serving a second waterproof function, the first connector having a second ceiling component, as the first function portion, to provide the second waterproof function by making press contact of one portion of the second ceiling component with the second connector and to provide a function of enhancing the second waterproof function by abutting another portion of the second ceiling component against the ridge portion; and
the manufacturing system being configured to fit the selected one of the first connectors and the second connector to manufacture the fitted body, the fitted body serving the functions provided by cooperation of the first function portion and the second function portion.

2. The manufacturing system according to claim 1, wherein
the first ceiling component is a packing having: a first lip portion annularly protruding as the one portion to make press contact with the second connector; and a second lip portion annularly protruding as the another portion to face to the ridge portion through the gap.

1. The Manufacturing system according to claim 1, wherein the second ceiling component is a packing haying: a first lip portion annularly protruding as the one portion to make press contact with the second connector; and a second lip portion annularly protruding as the another portion to abut against the ridge portion.
